(19) United States
(12) Patent Application Publication
(10) Pub. No.: US 2011/0148296 A1
(43) Pub. Date: Jun. 23, 2011

(54) High-pressure discharge lamp

(75) Inventors: Joachim Arndt, Brieselang (DE); Uwe Fidler, Berlin (DE); Ralph Hauschild, Beelitz (DE)

(73) Assignee: OSRAM GESELLSCHAFT MIT BESCHRAENKTER HAFTUNG, Muenchen (DE)

(21) Appl. No.: 12/969,608

(22) Filed: Dec. 16, 2010

(30) Foreign Application Priority Data
Dec. 22, 2009 (DE) 102009055171.9

(51) Int. Cl. H01J 61/30

(52) U.S. Cl. 313/634

(57) ABSTRACT

In various embodiments, a high-pressure discharge lamp is provided. The high-pressure discharge lamp may include an elongated discharge vessel that is accommodated in a tubular outer bulb which is held at one end in a base, the outer bulb being surrounded by a second outer bulb, wherein the second outer bulb is fastened in the region of the base.

### CROSS-REFERENCE TO RELATED APPLICATION

This application claims priority to German Patent Application Serial No. 10 2009 055 171.9, which was filed Dec. 22, 2009, and is incorporated herein by reference in its entirety.

### TECHNICAL FIELD

Various embodiments relate to a high-pressure discharge lamp. Such lamps are, by way of example, high-pressure discharge lamps for general lighting or for photooptic purposes.

### BACKGROUND

EP 1 652 212 discloses a high-pressure discharge lamp having a ceramic discharge vessel that has protection against shattering by being surrounded by two jackets.

WO 2008/022929 discloses a discharge lamp that is enveloped by a plastic jacket for the particular purpose of protecting against shattering.

However, the application of such plastic jackets is restricted to lamps with a low operating temperature, since otherwise no suitable plastic is available.

### SUMMARY

In various embodiments, a high-pressure discharge lamp is provided. The high-pressure discharge lamp may include an elongated discharge vessel that is accommodated in a tubular outer bulb which is held at one end in a base, the outer bulb being surrounded by a second outer bulb, wherein the second outer bulb is fastened in the region of the base.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of various embodiments. In the following description, various embodiments are described with reference to the following drawings, in which:

FIG. 1 shows a high-pressure discharge lamp in accordance with various embodiments;

FIG. 2 shows a high-pressure discharge lamp in accordance with various embodiments in side view (FIG. 2a) and in detail (FIG. 2b); and

FIG. 3 a high-pressure discharge lamp in accordance with various embodiments.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

Various embodiments provide a high-pressure discharge lamp that is compact and nevertheless has adequate protection against explosion.

This is valid, in various embodiments, for metal halide lamps, ceramic being possible as the material of the discharge vessel.

The rapidly developing luminaire market requires lamps that are evermore compact, that is to say of small diameter and length, and at the same time protected against explosion, and which can be operated in open luminaires. By comparison with screw bases, it is possible to achieve smaller dimensions through specific solutions in the base/socket region. Various embodiments relate to explosion-protected lamps having two outer bulbs in the entire power range. Here, the second outer bulb is an envelope that serves as protection against explosion for the possible destruction of the lamp in the event of negative influences. The fixing of the outer bulb must be performed such that the destruction of the lamp or other negative influences does not or do not damage the outer bulb. Furthermore, the outer bulb must also be protected against rotating in relation to the base, in order to ensure that the lamp can be turned on and off without any problem.

Various embodiments relate, for example, to explosion-protected lamps with outer bulbs and an envelope in the low power range up to at most 150 W. Here, the envelope may serve as protection against explosion for the possible destruction of the lamp by negative influences. The envelope is, for example, made from glass or plastic, but in any case should be resistant to high temperatures and suitable to be used for lighting purposes.

At present, only injection and dipping methods are known for coating outer bulbs with temperature-stable plastics, but it is possible to use the latter only in the case of relatively high power lamps with large (relatively cold) outer bulbs.

It is standard practice still to provide explosion-protected lamps with a second outer bulb. At present, three methods are known for fixing outer bulbs.

1. The conventional sealing of the outer bulb with the aid of a sealing foot.

2. The fixing of the outer bulb with the base via cementation.

3. The fastening of the outer bulb by means of a rolled-on aluminum ring on the outer bulb flange.

Aspects of various embodiments are:

The second outer bulb, e.g. made from hard glass, may be fixed by deformation after an appropriate heating operation in the pinch region of the basic lamp, e.g. with an outer bulb made from silica glass. In this case, the two normally different glasses of the two outer bulbs are not permitted to be connected by fusing (different expansion coefficient).

In various embodiments, a spring in the dome region ensures the necessary prestressing of the basic lamp in the outer bulb in order to avoid rattling or shaking of the second outer bulb.

During pinching of the second outer bulb or enveloping, smaller geometries may be attained than in the case of conventional lamps. It is therefore also possible to use a smaller base dimension than previously customary. The lamp thereby may become narrower and smaller.

In various embodiments, the fastening of the second outer bulb may be implemented in another way. The second outer bulb may be provided with lateral bores or holes at the level of the base. At these positions, the base has holes or cutouts for holding a pin-like fastening means, for example a splint, rivet, pin, screw or the like. The outer bulb may therefore be fixed by means of a splint, rivet, pin, a screw or the like that is driven into the base from outside through the bore/hole. The fastening may meet the requirement for the outer bulb to be held on the base, and may also fulfil the protection against rotation.

In various embodiments, prestressing of the second outer bulb on a supporting plateau of the base for the second outer bulb is achieved by means of a specific spring disk, e.g. made from metal, by virtue of the fact that the spring disk is compressed by compressive force before the system is pinned. In this state, the second outer bulb is fixed by pressing in at least one pin or similar, e.g. two opposite pins or similar. The compression spring or spring disk, also denoted as disk spring as known per se, may be intended to prevent the second outer bulb from wobbling and shaking on the supporting plateau. The pins may include or consist of metal or else of plastic. This process may be very time economic and requires no additional process outlay such as cementing, fusing or rolling on.

The second outer bulb may also in principle be fabricated from plastic to the extent that the latter is sufficiently thermostable. Particularly suitable, at least proportionately, as plastic for such an envelope are polycarbonate, polyester, polymethyl methacrylate or polyolefin. By way of example, transparent, UV stable plastics that are stable at high temperatures, e.g. Teflon, PTFE, may be suitable.

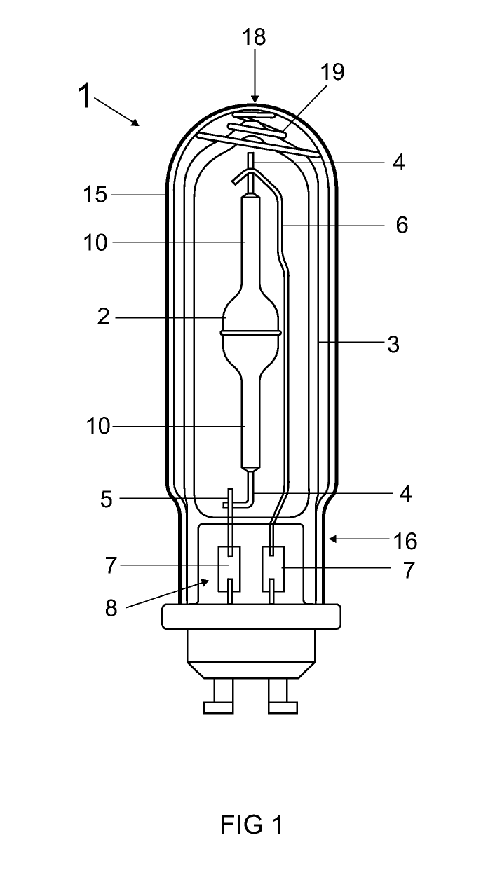

FIG. 1 shows the design of a high-pressure discharge lamp 1 in a very schematic fashion. As basic lamp, it has a discharge vessel 2 that may be accommodated in an outer bulb 3. The external supply leads 4 of the discharge vessel, which make contact with electrodes in the interior, may be connected to two frame wires 5 and 6. A short frame wire 5 leads to a first foil 7 in a pinch 8 of the outer bulb. A long frame wire 6, frequently termed clamp wire, leads to a second foil 7 in the pinch 8. The discharge vessel 2 respectively may have at its ends a capillary 10, as known per se, as well as a fill made from an ionizable gas, as a rule argon or xenon, mercury and metal halides, as likewise known per se. Two electrodes may be opposite one another in the interior of the discharge vessel, as likewise known per se and not illustrated here.

The outer bulb 3 may be surrounded by a second outer bulb or envelope 15 made from hard glass which bears tightly against the outer bulb 3. This second outer bulb 15 may include or consists of hard glass, while the inner outer bulb 3 may be fabricated from silica glass. The second outer bulb 15 may be fastened directly on the first outer bulb 3 approximately at the level of the pinch 8 thereof by a “soft” pinch 16. By this is meant a form-fitting integration of the outer bulb, a slight clear distance initially remaining. Moreover, the outer bulb 3 of the basic lamp may be centered in the dome 18 of the second outer bulb by a wedge-shaped downwardly expanding spring 19, or similar, as known per se. Final fixing of the outer bulb is performed by the spring force of the spring 19.

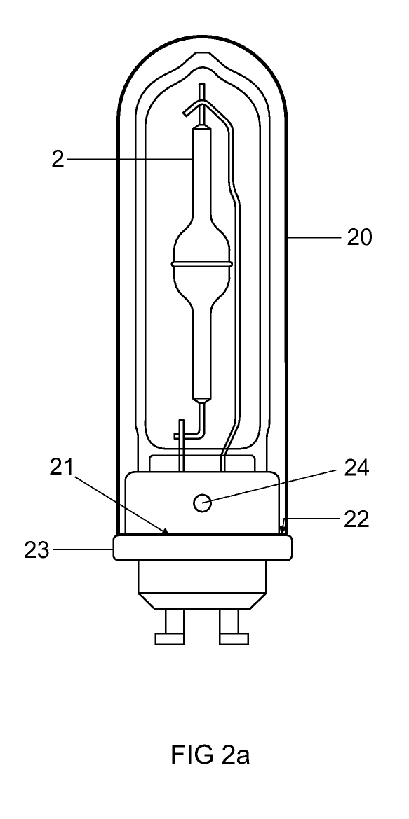

FIG. 2 shows an embodiment that takes better account of the high temperature load. In this case, in the side view of FIG. 2a, the second outer bulb 20 may be provided with a cylindrical opening 21 at the base end. The second outer bulb 20 may be mounted in this case on a stop 22 that projects laterally at the base 23. It may be fastened there by means of a splint 24 (see FIG. 2b). For this purpose, the second outer bulb may have a hole 25 through which the split 24 may be inserted into a cutout 26 in the base.

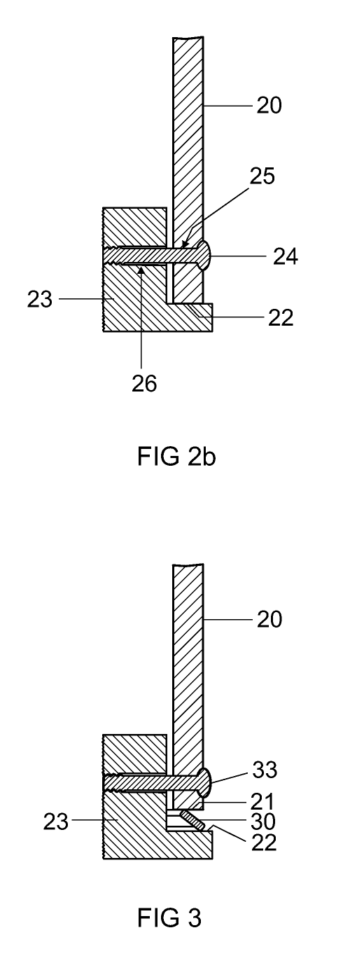

FIG. 3 is of similar design to FIG. 2. Here, however, in the region of the stop 22 an annular disk spring 30 may rest against the edge of the base, which serves as stop 22 and against which, in turn, the opening 21 of the second outer bulb rests. The spring force of the disk spring 30 may permit the second outer bulb 20 to press against the stop 22 of the base, the second outer bulb in the pressed state being fixed with the aid of two shaped pins 33.

Suitable as glass for the second outer bulb 20 are all possible glasses, such as soft glass or else silica glass, hard glass such as borosilicate glass, etc. being particularly suitable.

The discharge vessel 2 need not be made from ceramic; it can also be fabricated from silica glass or the like.

In principle, various embodiments may consist in that a high-pressure discharge lamp has a ceramic discharge vessel that is accommodated in an outer bulb, the outer bulb being, moreover, surrounded by a second outer bulb as protection against shattering that bears tightly against the outer bulb. Here, the outer bulb mostly has a base at one end and the discharge vessel is equipped with two ends.

Various embodiments and implementations thereof may have the following features:

A high-pressure discharge lamp may be provided having an elongated discharge vessel that is accommodated in a tubular outer bulb which is held at one end in a base, the outer bulb being surrounded by a second outer bulb, wherein the second outer bulb is fastened in the region of the base.

In various embodiments, the discharge vessel may be fabricated from ceramic and may have, by way of example, two capillaries.

In various embodiments, the second outer bulb may be attached to the first outer bulb in the region of the pinch thereof.

In various embodiments, the second outer bulb may be fastened mechanically directly on the base by having at least one hole that cooperates with a fitting cutout in the base, the fastening being performed with the aid of a pin-like fastening means that is guided through the hole and anchored in the cutout.

In various embodiments, the second outer bulb may be fabricated from hard glass or plastic.

In various embodiments, the second outer bulb may be seated on a stop for the base.

In various embodiments, seated on the stop is a disk spring on which, for its part, the second outer bulb is seated with an opening.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A high-pressure discharge lamp comprising:
an elongated discharge vessel that is accommodated in a tubular outer bulb which is held at one end in a base, the outer bulb being surrounded by a second outer bulb,
wherein the second outer bulb is fastened in the region of the base.

2. The high-pressure discharge lamp as claimed in claim 1,
wherein the discharge vessel is fabricated from ceramic.

3. The high-pressure discharge lamp as claimed in claim 2,
wherein the discharge vessel has capillaries.

4. The high-pressure discharge lamp as claimed in claim 3,
wherein the discharge vessel has two capillaries.

5. The high-pressure discharge lamp as claimed in claim 1,
wherein the second outer bulb is positioned in form-fitting fashion on the first outer bulb in the region of the pinch thereof.

6. The high-pressure discharge lamp as claimed in claim 1,
wherein the second outer bulb is fastened mechanically directly on the base by having at least one hole that cooperates with a fitting cutout in the base, the fastening being performed with the aid of a pin-like fastening means that is guided through the hole and anchored in the cutout.

7. The high-pressure discharge lamp as claimed in claim 1,
wherein the second outer bulb is fabricated from hard glass or plastic.

8. The high-pressure discharge lamp as claimed in claim 6,
wherein the second outer bulb is seated on a stop for the base.

9. The high-pressure discharge lamp as claimed in claim 8,
wherein seated on the stop is a disk spring on which, for its part, the second outer bulb is seated with an opening.
